(19) United States
(12) Patent Application Publication
(10) Pub. No.: US 2007/0083547 A1
(43) Pub. Date: Apr. 12, 2007

(54) Method and device for automatically representing data filed in data areas

(76) Inventor: Thomas Schnauffer, North Bondi (AU)

Correspondence Address: CANTOR COLBURN, LLP, 55 GRIFFIN ROAD SOUTH, BLOOMFIELD, CT, 06002, US

(21) Appl. No.: 11/496,671

(22) Filed: Jul. 31, 2006

(30) Foreign Application Priority Data
Aug. 1, 2005 (EP) 05 016 761.8

(51) Int. Cl. G06F 7/00

(52) U.S. Cl. 707/102

(57) ABSTRACT

The invention relates to a method and device for automatically representing data (D) filed in data areas, in which the data filed in a database (1) in columns and rows are exportable via an intermediate store (2) formed as a storage place into a graphic-capable application, in such a manner that a dialogue box (3) allows selection of the number of column and/or row headers and of the position of a count variable, and in that a formatting device formats the selection thus made according to the desired type of representation and a representation device, such as a screen or printer, represents the selected data sets in the form of a curve (6, 6a) and/or bar chart (6, 6b).

### FIELD OF THE INVENTION

The invention relates to a method and device for automatically representing data filed in data areas.

### DESCRIPTION OF RELATED ART

Such methods and devices are important especially for statistical purposes and prognoses in the various fields of technology, healthcare and commerce and population development, in order for example to be able to draw from the sale of certain products at specified intervals, such as months, to different circles of buyers, conclusions as to expected future buying behaviour. This is important for all areas of statistical control, such as what is known as “just-in-time production” of e.g. motor vehicle accessories, but particularly also in healthcare, in order that sufficient medicines, inoculation materials and the like are available without any considerable overproduction, since otherwise, with respect to what is known as the expiry date of medicines and foodstuffs, too large a surplus would be produced.

### BRIEF SUMMARY OF THE INVENTION

The invention is intended to overcome the technical problem of representing any links of data, which are allocated to different so-called “count variables”, graphically by means of hardware and software, in such a manner that the observer can detect the statistical variables and the relevant development from a past period virtually “at a glance” without lengthy written or verbal explanations and can derive therefrom a control variable for the future control and development.

This problem or task is solved by the invention claimed in claims 1 and 7 on the one hand of a method and on the other hand of a device. Further embodiments and improvements of the invention will appear from the following description and from the drawing with its explanation.

For clarity, the following terms are explained:

A “results table” or “matrix report” is the arrangement stored in the database as a table of data determined about for example specified periods of data determination, certain products, certain fields of application and certain buyers or patient groups, and consists of rows (first analysis variables) and columns (second analysis variables).

A “count variable” (e.g. patient number, number of prescriptions) is a numerical value to be analysed within the results table, e.g. the number of patients within a data capture period. An associated number of count variables is to be represented graphically as a curve and/or bars in a diagram. The arrangement in matrices or blocks is variable.

The “intermediate storage” is a storage place in the data processing apparatus or computer, which supports both text formats and graphics formats. The intermediate storage represents a further development of the functions “copy” and “paste” of the data processing apparatus and is known per se.

“Blocks” are data areas arranged as a matrix with headers over columns and in front of rows. A header has plural positions (e.g. four columns and three rows). The positions may have plural elements (members). In FIG. 1a, the block shown therein has two column headers and two row headers with respectively four positions. In this case, in the first (upper) column header the month elements January and February are located, and in the second column header below, the elements male and female. In the first front row header, the elements A and B are located, e.g. different products, and in the second row header the elements U and G, in particular turnover and profit of the respective products A and B. Additionally, one element has the property “has measure”, i.e. whether a count variable or otherwise is involved.

“Column heads” are headers over such blocks and correspondingly “row heads” are headers of the respective rows.

“Nested column heads” are multi-line column headings, such as are shown in FIG. 1a for example, and “nested row heads” are correspondingly multi-line row headers also as in the example of FIG. 1A.

In the invention, the data filed in a database are reprocessed. However, the invention is not limited to data already stored in databases for a relatively long time wherever possible; rather, the invention is also applicable in current data measurements, in which the measured data is directly reprocessed in the manner according to the invention and made visible in the form of curves and/or bars. This can be done on a screen and otherwise via e-media for representation at widely remote locations, but also by the use of print media.

In the invention, the results tables or matrix reports are reprocessed, in particular are formatted into a graphics-capable application and after nesting of the column heads and resolution into blocks by sorted discharging of the data into a new table (e.g. according to MS Excel) are inserted via an intermediate storage into this table software. Due to the complexity of the total and grouping formation, in reprocessing according to the invention a programmatic solution is applied, i.e. that for each constellation of the data (number of headers, positions of the count variables), up to 16 program parts can be set up. Such examples are shown below in a non-limiting manner for blocks with column and row heads and data with a count variable.

I. 1 Column and 1 Row Headers

a. with a count variable for all data

| |P1|P2| . . .
|X1|10|5| . . .
|X2|10|5| . . .
| . . .
| |P1|P2| . . .
|X1|10|5| . . .
|X2|10|5| . . .
| . . .

b. with count variable in 1^{st} column header

| |P1|P2| . . .
|Rev|10|5| . . .
|COS|10|5| . . .
| . . .
| |Rev| . . . | |COS| . . .
|P1|10| . . . |P1|5| . . .
|P2|11| . . .|P1|6| . . .
| . . .

c. with count variable in 1^{st} row header

| |Rev|COS| . . .
|P1|10|5| . . .
|P2|11|5| . . .
| . . .
| |P1|P2| . . .
|Rev|10|5| . . .
| | | |
| . . . |P1|P2| . . .
|COS|10|5| . . .
| . . .

II. 1 Column and 2 Row Headers

a. with a count variable for all data

| |P1|P2|P1|P2| . . .
|Y1|X1|10|5|10|5| . . .
|Y1|X2|10|5|10|5| . . .
|Y2|X1|10|5|10|5| . . .
|Y2|X2|10|5|10|5| . . .
| . . .
|Y1|P1|P2| . . .
|X1|10|5| . . .
|X2|10|5| . . .
|Y1|P1|P2| . . .
|X1|10|5| . . .
|X2|10|5| . . .

b. with count variable in 2^{nd} row header

| | |P1|P2|P1|P2| . . .
|X1|Rev|10|5|10|5| . . .
|X1|COS|10|5|10|5| . . .
|X2|Rev|10|5|10|5| . . .
|X2|COS|10|5|10|5| . . .
| . . .
|Rev|P1|P2| . . .
|X1|10|5| . . .
|
|COS|P1|P2| . . .
|X1|10|5| . . .
|X2|10|5| . . .
| . . .

c. with count variable in 1^{st} column header

| | |Rev|COS| . . .
|R1|P1|10|5| . . .
|R1|P2|10|5| . . .
|R2|P1|10|5| . . .
|R2|P2|10|5| . . .
| . . .
|R1|Rev| |R1|COS| . . .
|P1|10| |P1|5| . . .
|P2|10| |P2|5| . . .
| . . .
|R2|Rev| |R2|COS| . . .
|P1|10| |P1|5| . . .
|P2|10| |P2|5| . . .

III. 2 Column and 1 Row Headers

a. with a count variable for all data

| |Y1|Y1|Y2|Y2| . . .
| |P1|P2|P1|P2| . . .
|X1|10|5|10|5| . . .
|X2|10|5|10|5| . . .
|X1|10|5|10|5| . . .
|X2|10|5|10|5| . . .
| . . .
|Y1|P1|P2| . . .|Y2|P1|P2| . . .
|X1|10|5| . . .|X1|10|5| . . .
|X2|10|5| . . .|X2|10|5| . . .
| . . .

b. with count variable in 2^{nd} column header

| |P1|P1|P2|P2| . . .
| |Rev|COS|Rev|COS| . . .
|X1|10|5|10|5| . . .
|X2|10|5|10|5| . . .
|X1|10|5|10|5| . . .
|X2|10|5|10|5| . . .
| . . .
|Rev|P1|P2| |COS|P1|P2| . . .
|X1|10|5| |X1|10|5| . . .
|X2|10|5| |X2|10|5| . . .
| . . .

c. with count variable in 1^{st} row header

| |X1|X1| . . .|X2|X2| . . .
| |P1|P2| . . .|P1|P2| . . .
|Rev|10|5| . . .|5|5| . . .
|COS|11|5| . . .|6|5| . . .
| . . .
|X1|P1|P2| . . .|X2|P1|P2| . . .
|Rev|10|5| . . .|Rev|6|11| . . .
| |P1|P2| . . .|X2|P1|P2| . . .
|X1|P1|P2| . . .|X2|P1|P2| . . .
|COS|5|5| . . .|COS|5|5| . . .
| . . .

IV. 2 Column and 2 Row Headers

a. with one row variable for all data

| | |Y1|Y1|Y2|Y2| . . .
| | |P1|P2|P1|P2| . . .
|X1|Z1|10|5|10|5| . . .
|X1|Z2|10|5|10|5| . . .
|X2|Z1|10|5|10|5| . . .
|X2|Z2|10|5|10|5| . . .
| . . .
|X1 Y1|P1|P2| . . .|X1 Y2|P1|P2| . . .
|Z1|10|5| . . .|Z1|10|5| . . .
|Z2|10|5| . . .|Z2|10|5| . . .
| . . .
|X2 Y2|P1|P2| . . .|X2 Y2|P1|P2| . . .
|Z1|10|5| . . .|Z1|10|5| . . .
|Z2|10|5| . . .|Z2|10|5| . . .
| . . .

b. with count variable in 2^{nd} row header

| | |Y1 |Y1 |Y2 | Y2 |...
| | |P1 |P2 |P1 | P2 |...
| X1|Rev| 10| 5 |10 | 5 |...
| X1|COS| 10| 5 |10 | 5 |...
| X2|Rev| 10| 5 |10 | 5 |...
| X2|COS| 10| 5 |10 | 5 |...
|Rev Y1|P1 |P2|...|Rev Y2|P1 |P2 |...
|X1 | 10| 5|...|X1 | 10| 5|...
|X2 | 10| 5|...|X2 | 10| 5|...
|...
|COS Y2|P1 |P2|...|COS Y2|P1 |P2 |...
|X1 | 10| 5|...|X1 | 10| 5|...
|X2 | 10| 5|...|X2 | 10| 5|...
|...

c. count variable in 2^{nd} column header

| | |P1 |P2 |P2 | P2|...
| | |Rev|COS|Rev|COS|...
|R1 |X1 | 10| 5| 10| 5|...
|R1 |X2 | 10| 5| 10| 5|...
|R2 |X1 | 10| 5| 10| 5|...
|R2 |X2 | 10| 5| 10| 5|...
|...
|Rev R1|P1 |P2| |COS R1|P1 |P2 |...
|X1 | 10| 5| |X1 | 10| 5|...
|X2 | 10| 5| |X2 | 10| 5|...
|...
|Rev R2|P1 |P2| |COS R2|P1 |P2 |...
|X1 | 10| 5| |X1 | 10| 5|...
|X2 | 10| 5| |X2 | 10| 5|...
|...

In block formation, however, an iteration is carried out concerning the positions of the headers, so that in each case practical blocks are formed according to the definitions. Count variables allocated to the same or similar analysis variables are detected and assembled.

After block formation, graphic formation takes place. In this, a central graphic set-up routine is called up during the block formation. This then constructs a graphic on the block respectively set up. The block formation therefore decides by means of the number of positions in the blocks and by means of the count variables which type of graphic, curve representation or bar chart is to be used.

For selecting the number of columns and/or row headers and the positions of the count variables, advantageously a dialogue box is used.

### BRIEF DESCRIPTION OF THE DRAWINGS

Embodiments of the invention will be described below by means of the drawing, which shows:

FIG. 1 a diagram for the method according to the invention or the apparatus according to the invention;

FIG. 1a an example of the block already described above;

FIG. 2 an example of a “matrix-type” report and

FIG. 3 a corresponding block with the additional toolbar for “generate graphic” and “selected graphic data”;

FIGS. 4 & 4a examples of dialogue boxes according to the invention;

FIGS. 5 & 5a formatted blocks each with a (FIG. 5) column and row header and two column headers (FIG. 5a);

FIG. 6 an example of three graphics set up in a new “Excel spreadsheet”;

FIGS. 7 & 7a correspondingly selectively formatted graphics in the form of curves (FIG. 7) and bars (FIG. 7a) and

FIGS. 8 & 8a likewise selectively formatted, bar charts shown on the screen and printed out.

### DETAILED DESCRIPTION OF THE INVENTION

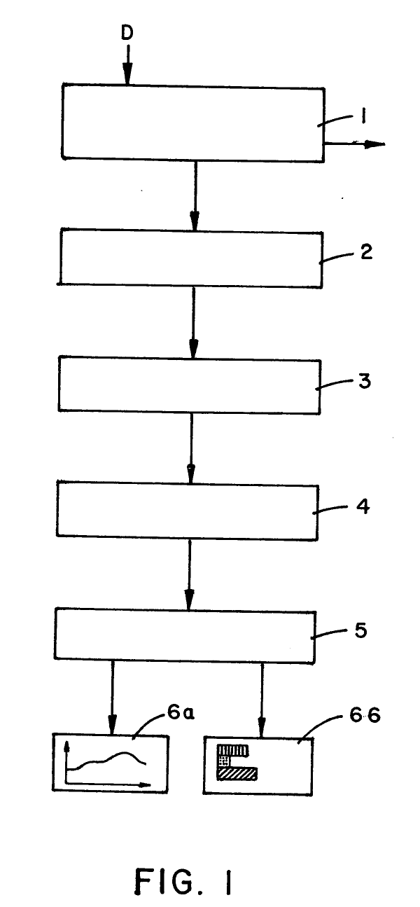

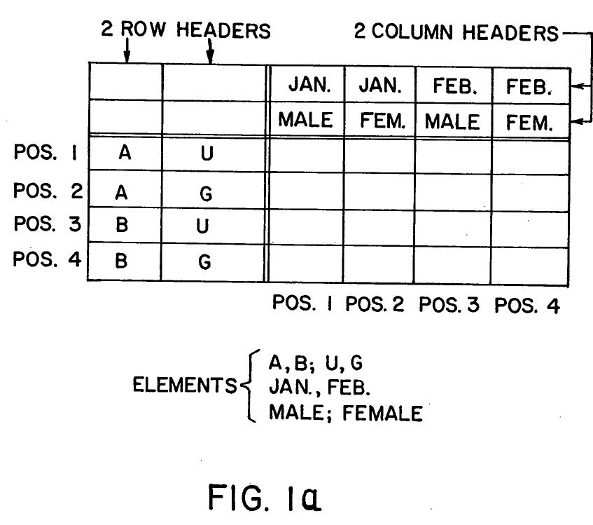

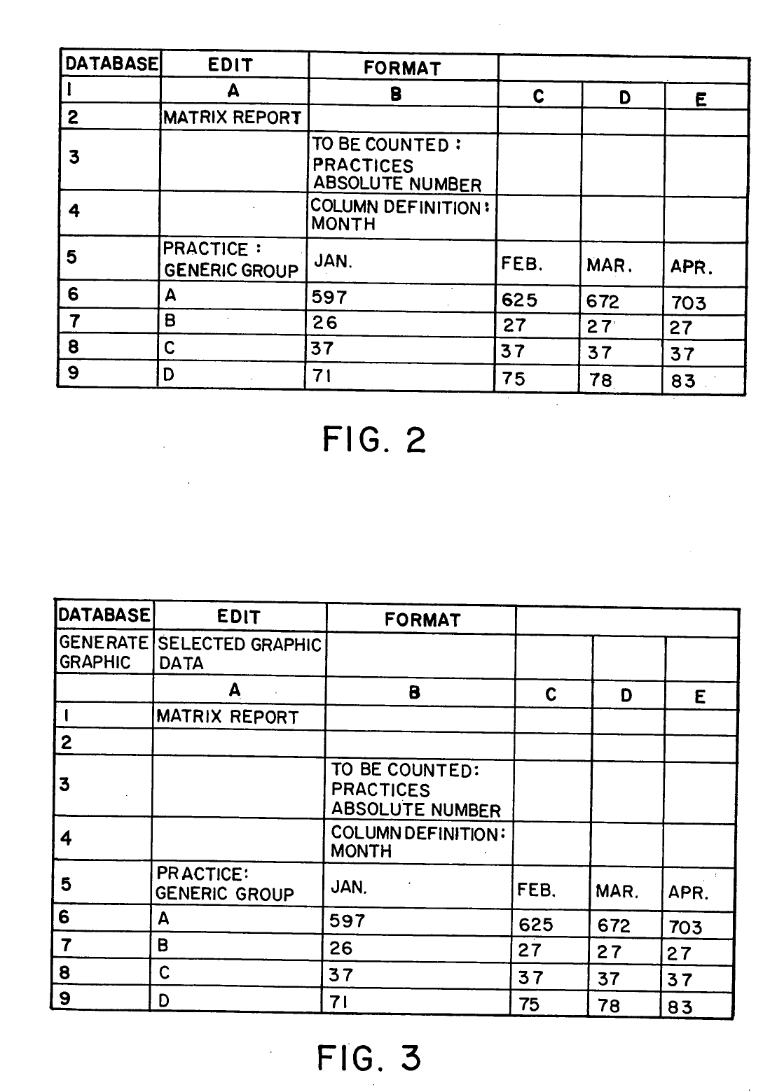

According to FIG. 1, data D are sorted in the database 1, in particular filed according to specific variables, such as period of capture, type of product, turnover variable, profit variable, consumer or patient property, e.g. gender or age group of the buyer or patient. Referring to FIG. 1a, A and B designate certain preparations, U the turnover variable and G the profit, January and February the relevant capture months and male and female the respective gender of the patient. In addition, for example, various fields of application, such as agent for reducing blood pressure, and antihistamine, could be captured in the database.

After appropriate nesting of the column and row heads with a region selection for setting up a graphic in particular according to MS Excel, resolution into blocks takes place and exporting into the intermediate store 2.

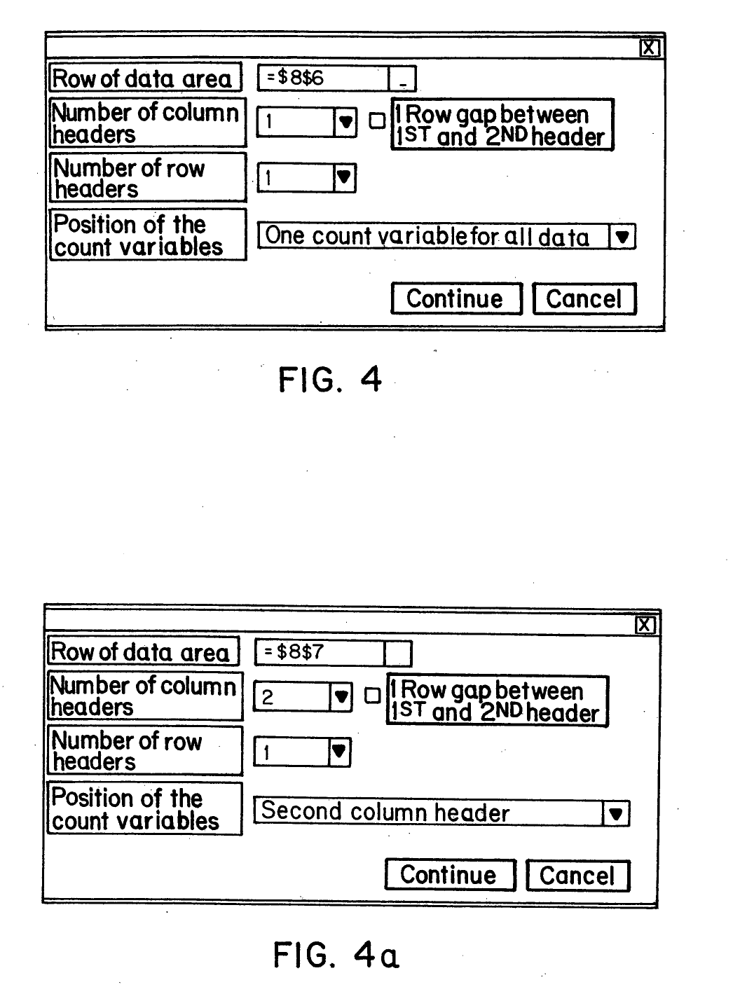

The operator has the option in the dialogue box 3 of a simple choice of number of column or row headers and of position of the count variables e.g. according to FIGS. 4/4a.

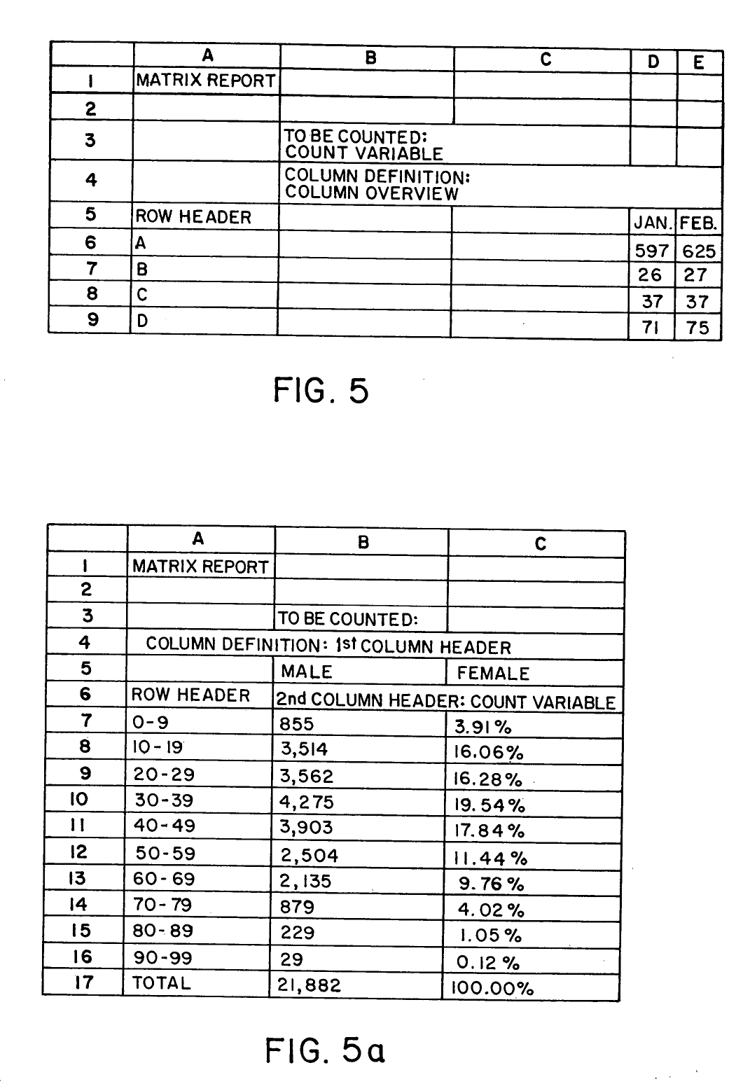

The selection device 4 allows the headers of the columns and rows to be selected (column and row heads) e.g. according to FIGS. 5/5a.

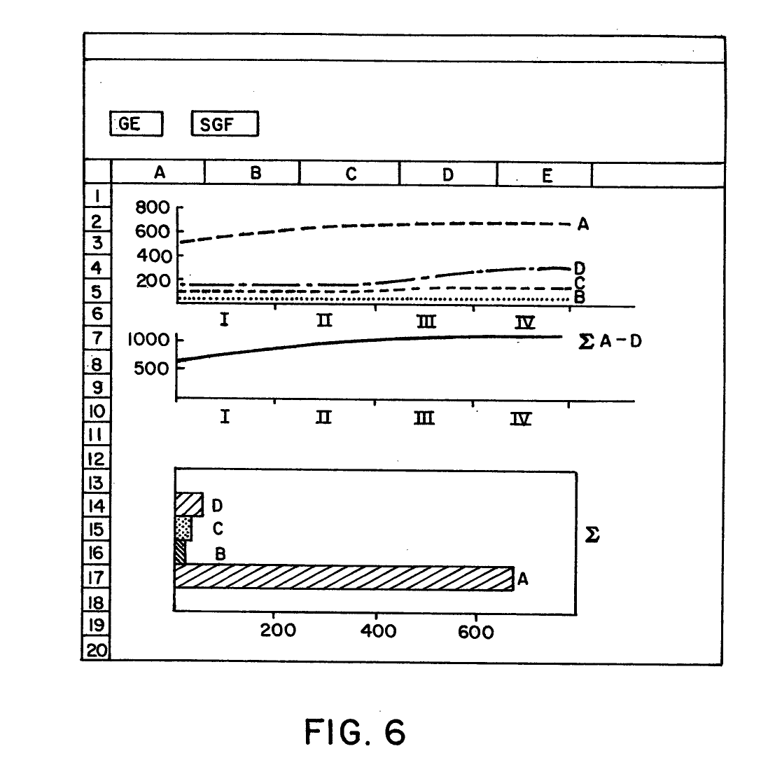

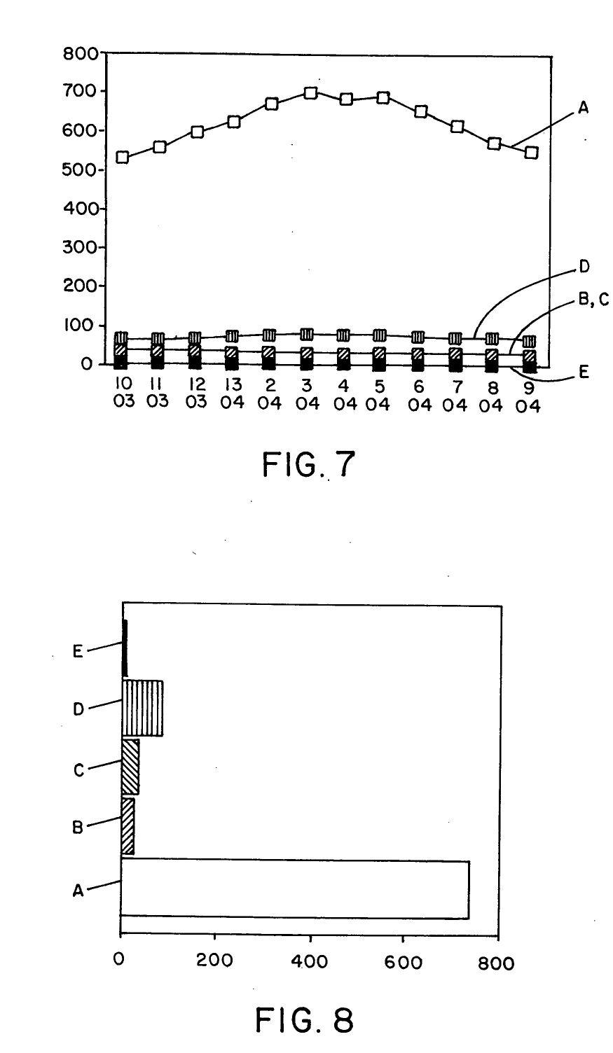

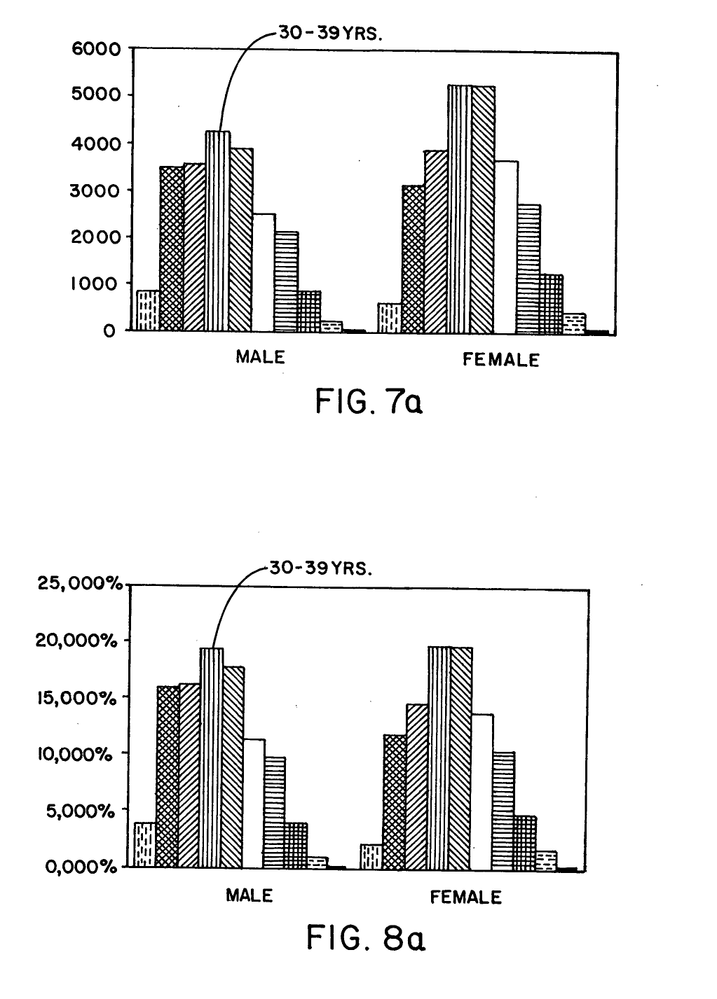

On the screen 5 a graphic total representation appears, for example according to FIG. 6 and in FIGS. 6a and 6b, screen representations in the form of curves (FIG. 7) and bar charts (FIGS. 8/8a) are shown.

In order to copy the data report stored in the database including the header “matrix report” via the intermediate store 2 into the graphic application, in particular “MS Excel”, the whole report is first highlighted on the screen and is inserted into MS Excel via the conventional processing steps “edit” and “copy” shown in the first toolbar.

To start the macro, which according to the invention appears on the screen with a second toolbar, the user clicks the button “generate graphic”, whereupon a dialogue box opens according to FIG. 4, in which the user can now make his choice in terms of number of column headers and row headers and position of the count variables.

With the field “cell of the data area”, the first row of the data area is defined. If the cursor is in this field, in the data table the preset first row of the data area is highlighted. If on the other hand the wrong cell is highlighted, this can be corrected by clicking again in the first cell of the data area. The value in the dialogue box is then automatically updated. The block image now appearing on the screen, according to FIG. 5, has according to numbers and variables input the dialogue box 2 a column header “month” and a row header “medicinal generic group A B C and D”. The data area contains only absolute values or only one count variable, e.g. the absolute number of practices.

With a click on the “continue” button of the dialogue box 3 of FIGS. 4/4a, then according to FIG. 6 three graphics are set up in a new Excel spreadsheet. In this case, in the first upper graphic, values are shown per generic group and month, in the second, middle graphic the total over all generic groups per month is shown, and the totals over the whole period per generic group are shown.

Should a visually clearer graphic representation be desired, the button “SGF” (format selected graphic) is pressed, after the corresponding graphic has been previously individually highlighted. The graphics according to FIGS. 7 and 8 can then be imaged in different colours or shades in order to be distinguished clearly visually from one another.

According to a further second example, according to FIG. 4a, the number 2 of column headers with the same number 1 of row headers and, as the position of the count variables, the second column header are selected. In this embodiment, the first column header might be the gender of the patient and the second column header, which contains the count variable, might contain the “patient number absolutely” and “patient vertical % (total)”. The row header in this embodiment of FIG. 4a could have the age group of the patients respectively in groups of 10 years, e.g. 0 to 9, 10 to 19, 20 to 29, 30 to 39 and so on. Since the position of the count variables forms the “2^{nd} column overview”, as the count variable the “patient number absolutely” and the “patient vertical % (total)” come into consideration. In this case also, after clicking on the “continue” button, a number of graphics are set up in a new Excel spreadsheet. For this, no separate drawing is added; for this, in FIGS. 7a and 8a those graphics are illustrated which are represented upon further formatting by pressing the “SGF” button on the screen advantageously in different colours but formatted to a uniform size. FIG. 7a clarifies in a visually very clear way the absolute number of patients from the various age groups separated into male and female, whilst in FIG. 8a the percentage proportion of patients of the various age groups is represented, again divided into male and female.

The invention generally fulfils the task of transforming complex orders of data into graphical outputs quick, easily, and in clearly arranged format.

As disclosed, in one exemplary embodiment, the invention is based on a data sheet with a data matrix such as, for example, an “Excel-data sheet” as produced by Microsoft, Corp. The data may comprise one- or more-dimensional data areas. Line and column headings can be processed together with the data.

A user of the invention merely has to define the data area and choose the number of data rows and columns. The transfiguration of the data is then received with one mouse click.

The invention allows a menu-driven transformation of data into diagrams. For simple data, this resembles the common use of Excel-diagrams. However, the invention is particularly advantageous with respect to complex data. Columns with different headings can automatically be converted into separate charts. Further, it is possible to produce several outputs identically repeated for different sorting criteria, e.g. target groups. Also, histograms, line diagrams and pie charts can be obtained. In this way, a large amount of data can be reshaped into a concise number of graphical plots.

If desired, the invention may be integrated into a customary Excel-program. In such case, the menu bar will be supplemented with a plurality of additional icons for using the invention. Particularly, the menu bar includes only three additional icons to support the invention.

The invention therefore represents an important technical aid for selecting certain count variables from the whole of the individual data stored in the database in a relatively simple manner, and after corresponding nesting, resolution into blocks and formatting, a means of representing visually in an optically clear or graphic manner. The representation can also be a useful aid for demonstration purposes in the form of what are known as “Power-Point” presentations, e.g. for production managers, development managers, purchase and sales managers in order to profit optimally from the results of such market research, in particular applied in a concrete manner in each case to their special information requirements. Time-consuming retrieval from lists and manual or mental linking of numerous data from such lists can therefore be avoided. The invention therefore represents an important technical tool for solving the technical problem cited in the introduction.

1. Method of automatically representing data filed in data areas, in which count variables filed in columns and lines are exported via an intermediate store into a graphic-capable application, a selection of column headers or row headers to be represented is made and the position of the count variables is determined and the respective count variables are represented after block formation as a curve and/or as bars.

2. Method according to claim 1, characterised in that data blocks are represented, which have data filed in columns and rows and column and row headers, from which a count variable may be selected.

3. Method according to claim 1, characterised in that nested column heads are resolved into data blocks.

4. Method according to claim 1, characterised in that a toolbar is shown on a screen, which makes available symbols representing necessary function commands.

5. Method according to claim 1, characterised in that the row or column headers are divided into at least two elements (members), which correspond to different properties of the data.

6. Method according to claim 1, characterised in that the headers are divided into plural positions.

7. Device for representing data filed in data areas, in which the data filed in a database in columns and rows are exportable via an intermediate store formed as a storage place into a graphic-capable application, in such a manner that a dialogue box on a screen permits selection of the number of column and/or row headers and selection of the position of a count variable of a data region (block), and in that a formatting device formats the selection thus made according to the desired type of representation and in that a representation device represents the selected data sets in the form of a curve and/or as a bar chart.

8. Device according to claim 7, characterised in that a data processing device shows at least one toolbar on a screen, which contains symbols of functions, such as “generate graphic” and “selected graphic formatting” and triggers these upon actuation.

9. Device according to claim 7, characterised in that the graphic-capable application represents data blocks (FIG. 1a) on a screen, which has data filed in columns and rows and column headers and row headers for count variables.

10. Device according to claim 7, characterised in that for each data constellation (number of headers, positions of the time variables), sixteen program parts are provided.

11. Device according to claim 7, characterised in that in order to form practical data blocks, iteration takes place concerning the positions of the headers.

12. Device according to claim 7, characterised in that a central graphic set-up routine is constructed for the data block respectively set up and in that the type of graphic depends on the number of positions in the data blocks and the count variables.
